(19) United States
(12) Patent Application Publication
(10) Pub. No.: US 2015/0260842 A1
(43) Pub. Date: Sep. 17, 2015

(54) ULTRASONIC SIGNAL PROCESSING APPARATUS, ULTRASONIC SIGNAL PROCESSING METHOD, AND PROGRAM

(71) Applicant: KONICA MINOLTA, INC., Tokyo (JP)

(72) Inventor: Yasuaki Susumu, Chuo-ku, Osaka-shi, Osake (JP)

(21) Appl. No.: 14/432,897

(22) PCT Filed: Oct. 8, 2013
(86) PCT No.: PCT/JP2013/005989

§ 371 Date: Apr. 1, 2015

(30) Foreign Application Priority Data
Oct. 12, 2012 (JP) 2012-226575

(51) Int. Cl. G01S 15/04

(52) U.S. Cl. CPC G01S 15/04

(57) ABSTRACT

An ultrasonic signal processing apparatus (1) includes a transducer element array (2), a transmission control unit (3), and a reception control unit (4). The transmission control unit includes a first code generation unit (200), a second code generation unit (201), and a pulser (112) that generates ultrasonic waves by (i) outputting a first code string (G1) at a first timing, and a second code string (G2) at a second timing, to a first transducer element (100), and (ii) outputting a third code string (G3) at the first timing, and a fourth code string (G4) at the second timing, to second transducer elements sandwiching the first transducer element. The reception control unit includes a decoding processing unit (210) that performs a first filtering process and a second filtering process on both of a first echo of the ultrasonic wave at the first timing, and a second echo of the ultrasonic wave at the second timing, and a code addition unit (211) that adds results of the first filtering process and adds results of the second filtering process.

### TECHNICAL FIELD

The present invention relates to an ultrasonic signal processing apparatus and the like that transmit an ultrasonic wave to a subject, and receives the echo of the ultrasonic wave reflected in the subject.

### BACKGROUND ART

The use of an ultrasonic wave using a Golay code to increase the S/N of an echo signal of the ultrasonic wave is known (e.g., refer to Patent Literature 1). The system described in Patent Literature 1 can prevent a reduction in frame rate upon dynamic focusing by use of the ultrasonic wave using the Golay code.

### CITATION LIST

### Patent Literature

Patent Literature 1: JP 4472802 B

### SUMMARY OF INVENTION

### Technical Problem

However, there is a problem that it is difficult to visualize the inside of a subject in both areas forward and backward of a focus position of the ultrasonic wave with high precision.

Hence, an object of the present invention is to provide an ultrasonic signal processing apparatus and the like that have been made to solve the above problem and can visualize the inside of a subject in both areas forward and backward of a focus position of an ultrasonic wave with high precision.

### Solution to Problem

In order to achieve the above object, an ultrasonic signal processing apparatus according to an aspect of the present invention includes: a transducer element array, including a plurality of transducer elements, for emitting an ultrasonic wave to a subject and receiving an echo of the ultrasonic wave reflected in the subject; a transmission control unit for causing the transducer element array to generate an ultrasonic wave in accordance with an encoded signal; and a reception control unit for decoding a signal in accordance with the echo received by the transducer element array, wherein in a case where (i) a first code pattern and a second code pattern, and a third code pattern and a fourth code pattern are two pairs of complementary sequences respectively satisfying a complementary sequence relationship, and (ii) the first code pattern and the third code pattern, and the second code pattern and the fourth code pattern are two pairs of orthogonal codes respectively satisfying an orthogonal code relationship, the transmission control unit includes a first code generation unit for generating a first code pair having a first code string formed by aligning the first code pattern and the third code pattern, and a second code string formed by aligning the second code pattern and the fourth code pattern, a second code generation unit for generating a second code pair having a third code string in which one of the code patterns of the first code string is replaced with a pause code pattern, and a fourth code string in which a code pattern of the second code string, which makes the pair of complementary sequences with the one of the code patterns, is replaced with the pause code pattern, and a pulser for causing the transducer element array to generate the ultrasonic waves by (i) outputting the first code string of the first code pair at a first timing, and the second code string at a second timing later than the first timing, to one or more first transducer elements among the plurality of transducer elements, and (ii) outputting the third code string of the second code pair at the first timing, and the fourth code string at the second timing, to a plurality of second transducer elements arranged in a position sandwiching the one or more first transducer elements, and the reception control unit includes a decoding processing unit for performing a first filtering process by a first filter for extracting one of the two pairs of complementary sequences, and a second filtering process by a second filter for extracting the other pair of complementary sequences, on both of a first echo of an ultrasonic wave output at the first timing in accordance with the first code string and the third code string and reflected in the subject, and a second echo of an ultrasonic wave output at the second timing in accordance with the second code string and the fourth code string and reflected in the subject, among the echoes received by the transducer element array, and a code addition unit for adding first results being results of the first filtering process on both of the first and second echoes, and adding second results being results of the second filtering process on both of the first and second echoes.

Their general or specific aspects may be realized by a system, a method, an integrated circuit, a computer program, or a computer-readable recording medium such as a CD-ROM, or may be realized by any combination of a system, a method, an integrated circuit, a computer program, and a recording medium.

### Advantageous Effects of Invention

The ultrasonic signal processing apparatus and ultrasonic signal processing method of the present invention can visualize the inside of a subject in both areas forward and backward of a focus position of an ultrasonic wave with high precision.

### BRIEF DESCRIPTION OF DRAWINGS

FIG. 1 is a block diagram illustrating the configuration of an ultrasonic signal processing apparatus of a first embodiment.

FIG. 2 is a block diagram illustrating a decoding processing unit.

FIG. 3 is a flowchart of the generation of a transmit ultrasonic signal.

FIG. 4 is a diagram illustrating the relationship between codes and transmit apertures.

FIG. 5 is a flowchart of a method for decoding a receive ultrasonic signal.

FIG. 6 is a block diagram illustrating the configuration of an ultrasonic signal processing apparatus according to a second embodiment.

FIG. 7 is a flowchart of a weight processing unit.

FIG. 8 is a diagram illustrating an example of a transducer element array where a plurality of transducer elements is lined one-dimensionally.

FIG. 9 is a diagram illustrating examples of a transducer element array where a plurality of transducer elements is lined two-dimensionally.

FIG. 10 is a flowchart for illustrating an ultrasonic signal processing method to be performed by the ultrasonic signal processing apparatus.

### DESCRIPTION OF EMBODIMENTS

(Fundamental Findings of the Present Invention)

The inventor found that the following problems arise in the system described in “Background Art.”

Golay codes are code sequences having the property that aperiodic autocorrelation functions of two code sequences sum to zero, except at the zero-shift position. For example, in a case where a sequence S1 and a sequence S2, which are illustrated in (Equation 1) and have the same length L, are biphase (+, −) Golay codes, S1 and S2 satisfy the condition of (Equation 2).

$$\begin{matrix} S 1 = [ s {1}_{1} , s {1}_{2} , … , s {1}_{L} ] , S 2 = [ s {2}_{1} , s {2}_{2} , … , s {2}_{L} ] & [ Math . 1 ] \\ {RS}_{S 1} ( τ ) + {RS}_{S 2} ( τ ) = {\sum }_{n = 1}^{L - τ} ( s {1}_{n} s {1}_{L - n - 1} + s {2}_{n} s {2}_{L - n - 1} ) = 0 ( τ \neq 0 ) & [ Math . 2 ]\end{matrix}$$

In (Equation 2), RS denotes an autocorrelation function and τ denotes time shifting.

Although an ultrasonic echo signal is conventionally used, there is conventionally a problem that the resolution at shallow depths and the sensitivity at deep depths are in a trade-off relationship due to the influence of a transmit beam when image diagnosis and non-destructive testing are performed. Specifically, if a transmit aperture for transmitting a transmit beam is small, an ultrasonic wave is transmitted from a small area. Hence, the azimuth resolution becomes better at a position close to the probe than the focus position while it becomes harder for the ultrasonic wave to reach a position distant from the probe than the focus position. Moreover, if the transmit aperture for transmitting a transmit beam is large, an ultrasonic wave is transmitted from a large area. Hence, it is easy for the ultrasonic wave to reach a position distant from the probe than the focus position while the azimuth resolution becomes worse at a position close to the probe than the focus position.

In order to solve such a problem, an ultrasonic signal processing apparatus according to one aspect of the present invention includes: a transducer element array, having a plurality of transducer elements, for emitting an ultrasonic wave to a subject and receiving an echo of the ultrasonic wave reflected in the subject; a transmission control unit for causing the transducer element array to generate an ultrasonic wave in accordance with an encoded signal; and a reception control unit for decoding a signal in accordance with the echo received by the transducer element array, wherein in a case where (i) a first code pattern and a second code pattern, and a third code pattern and a fourth code pattern are two pairs of complementary sequences respectively satisfying a complementary sequence relationship, and (ii) the first code pattern and the third code pattern, and the second code pattern and the fourth code pattern are two pairs of orthogonal codes respectively satisfying an orthogonal code relationship, the transmission control unit includes a first code generation unit for generating a first code pair having a first code string formed by aligning the first code pattern and the third code pattern, and a second code string formed by aligning the second code pattern and the fourth code pattern, a second code generation unit for generating a second code pair having a third code string in which one of the code patterns of the first code string is replaced with a pause code pattern, and a fourth code string in which a code pattern of the second code string, which makes the pair of complementary sequences with the one of the code patterns, is replaced with the pause code pattern, and a pulser for causing the transducer element array to generate the ultrasonic waves by (i) outputting the first code string of the first code pair at a first timing and the second code string at a second timing later than the first timing, to one or more first transducer elements among the plurality of transducer elements, and (ii) outputting the third code string of the second code pair at the first timing, and the fourth code string at the second timing, to a plurality of second transducer elements arranged in a position sandwiching the one or more first transducer elements, and the reception control unit includes a decoding processing unit for performing a first filtering process by a first filter for extracting one of the two pairs of complementary sequences, and a second filtering process by a second filter for extracting the other pair of complementary sequences, on both of a first echo of an ultrasonic wave output at the first timing in accordance with the first code string and the third code string and reflected in the subject, and a second echo of an ultrasonic wave output at the second timing in accordance with the second code string and the fourth code string and reflected in the subject, among the echoes received by the transducer element array, and a code addition unit for adding first results being results of the first filtering process on both of the first and second echoes, and adding second results being results of the second filtering process on both of the first and second echoes.

Consequently, in one ultrasonic transmission using a pair in a complementary sequence relationship, both of an ultrasonic wave through a transmit aperture set to be small, and an ultrasonic wave through a transmit aperture being larger than the transmit aperture and including at least the transmit aperture can be transmitted. In addition, the separation of both of the ultrasonic waves is easy and, accordingly, the inside of a subject can be visualized in both areas forward and backward of the focus position of the ultrasonic wave with high precision.

Moreover, for example, the transmission control unit may determine not to oscillate the transducer element, to oscillate the transducer element as the first transducer element, or to oscillate the transducer element as the second transducer element, based on a predetermined F-number, for each of the plurality of transducer elements forming the transducer element array.

Moreover, for example, an operating unit for accepting an operator's input related to a focal length may be further included. The transmission control unit may determine not to oscillate the transducer element, to oscillate the transducer element as the first transducer element, or to oscillate the transducer element as the second transducer element, based on a position accepted by the operating unit, for each of the plurality of transducer elements forming the transducer element array.

Moreover, for example, a weight processing unit may be further included which multiplies the first result by its corresponding first weight, and multiplies the second result by its corresponding second weight.

Moreover, for example, the weight processing unit may determine the first and second weights to be equal at a preset focus position based on the focus position.

Moreover, for example, the weight processing unit may determine one of the first and second weights multiplied by one of the first and second results being results of the decoding process on echoes of ultrasonic waves with code patterns included in common in the first and second code pairs, the ultrasonic waves having been reflected in the subject, to be smaller in an area more forward of the focus position and be larger in an area toward backward of the focus position, than the other of the first and second weights multiplied by the other of the first and second results.

Moreover, for example, the weight processing unit may determine the first and second weights to be a constant value upon being added up, regardless of a distance from the focus position.

Their general or specific aspects may be realized by a system, a method, an integrated circuit, a computer program, or a computer-readable recording medium recording medium such as a CD-ROM, or may be realized by any combination of a system, a method, an integrated circuit, a computer program, and a recording medium.

Hereinafter, an ultrasonic signal processing apparatus and an ultrasonic signal processing method according to one aspect of the present invention are specifically described with reference to the drawings. The same reference numerals are assigned to the same elements, and their descriptions may be omitted.

Any of the embodiments described below illustrates a specific example of the present invention. Numerical values, shapes, components, arranged positions and connection forms of the components, steps, the order of the steps, and the like that are presented in the following embodiments are examples, and do not purport to limit the present invention. Moreover, among the components in the following embodiments, components that are not described in the independent claims indicating the most generic concepts are illustrated as arbitrary components.

### First Embodiment

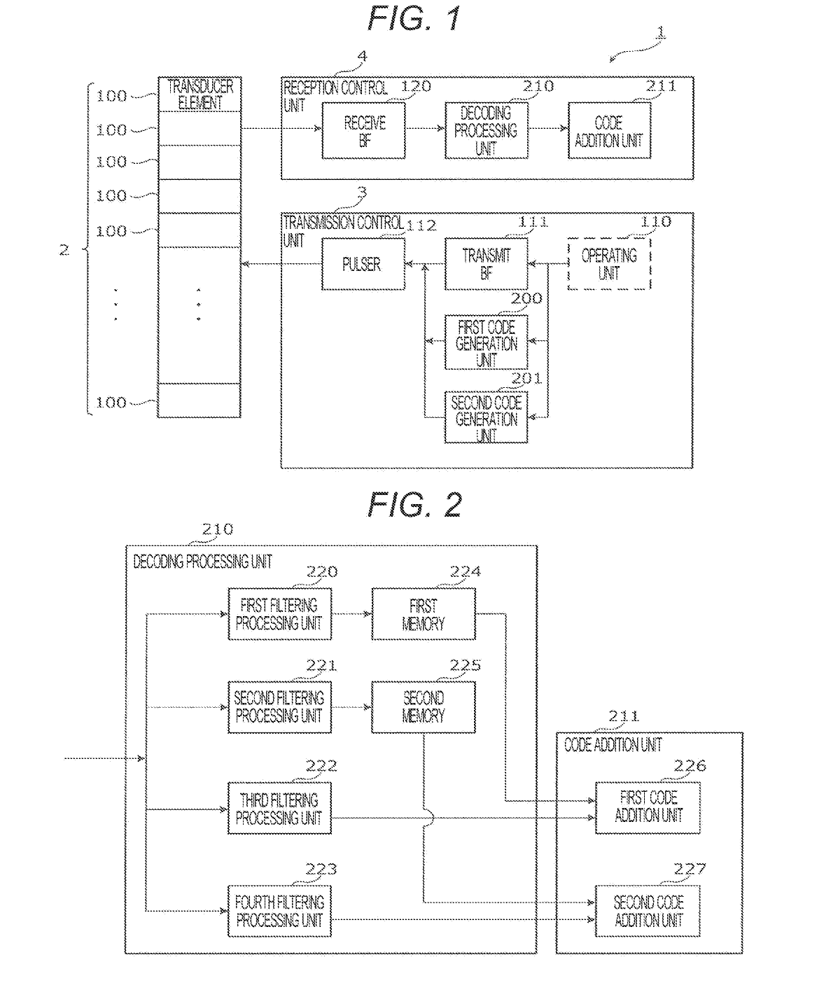

FIG. 1 is a block diagram illustrating the configuration of an ultrasonic signal processing apparatus of a first embodiment.

An ultrasonic signal processing apparatus 1 includes a transducer element array 2, a transmission control unit 3, and a reception control unit 4. The transducer element array 2 includes a plurality of transducer elements 100. The transducer element array 2 emits an ultrasonic wave to a subject, and receives an echo of the ultrasonic wave reflected in the subject. The transmission control unit 3 includes an operating unit 110, a transmit BF (Beam Former) 111, a pulser 112, a first code generation unit 200, and a second code generation unit 201. The reception control unit 4 includes a receive BF (Beam Former) 120, a decoding processing unit 210, and a code addition unit 211.

The transducer element array 2 includes the plurality of transducer elements 100. The transducer element array 2 emits an ultrasonic wave to the subject, and receives an echo of the ultrasonic wave reflected in the subject.

The transmission control unit 3 causes the transducer element array 2 to generate an ultrasonic wave including an encoded signal.

The reception control unit 4 decodes a signal included in the echo received in the transducer element array 2.

FIG. 2 is a block diagram illustrating the configurations of the decoding processing unit and the code addition unit of the first embodiment.

The decoding processing unit 210 includes a first filtering processing unit 220, a second filtering processing unit 221, a third filtering processing unit 222, and a fourth filtering processing unit 223, a first memory 224, and a second memory 225. The code addition unit 211 includes a first code addition unit 226 and a second code addition unit 227.

The block diagram of the ultrasonic signal processing apparatus 1 is described using FIG. 1.

The operating unit 110 accepts an operator's input related to the focal length. The operating unit 110 calculates a transmit beam signal, a first code signal, and a second code signal from the accepted operation signal. The operating unit 110 outputs the calculated transmit beam signal to the transmit BF 111, outputs the calculated first code signal to the first code generation unit 200, and outputs the calculated second code signal to the second code generation unit 201.

The transmit BF 111 calculates a transmit beam profile from the input transmit beam signal, and outputs the calculated transmit beam profile to the pulser 112.

The first code generation unit 200 calculates a first code pair from the input first code signal, and outputs the first code pair to the pulser 112.

The second code generation unit 201 calculates a second code pair from the input second code signal, and outputs the first code pair to the pulser 112.

The pulser 112 outputs a drive signal to drive the plurality of transducer elements 100 of the transducer element array 2 to the plurality of transducer elements 100, based on the transmit beam profile output by the transmit BF 111, the first code pair generated by the first code generation unit 200, and the second code pair generated by the second code generation unit 201.

The plurality of transducer elements 100 outputs, into the subject, an ultrasonic wave based on the input drive signal.

The plurality of transducer elements 100 then receives an echo reflected in the subject in accordance with a difference in the acoustic impedance in the subject.

The plurality of transducer elements 100 generates an RF (Radio Frequency) signal based on the received echo, and outputs the generated RF signal to the receive BF 120.

The receive BF 120 calculates a DAS (Delay and Sum) signal from the input RF signal, and outputs the calculated DAS signal to the decoding processing unit 210.

The decoding processing unit 210 calculates first decoded data and second decoded data from the input DAS signal, and outputs the calculated first and second decoded data to the code addition unit 211.

The code addition unit 211 calculates added decoded data from the input first and second decoded data, and outputs the calculated added decoded data.

Next, the block diagram of the decoding processing unit is described using FIG. 2.

The first filtering processing unit 220 calculates code data A from the input DAS signal, and outputs the calculated code data A to the first memory 224.

The second filtering processing unit 221 calculates code data B from the input DAS signal, and outputs the calculated code data B to the second memory 225.

The third filtering processing unit 222 calculates code data C from the input DAS signal, and outputs the calculated code data C to the first code addition unit 226.

The fourth filtering processing unit 223 calculates code data D from the input DAS signal, and outputs the calculated code data D to the second code addition unit 227.

The code data A is saved in the first memory 224 until the timing when the third filtering processing unit 222 outputs the code data C to the first code addition unit 226. The first memory 224 outputs the code data A to the first code addition unit 226 at that timing.

The code data B is saved in the second memory 225 until the timing when the fourth filtering processing unit 223 outputs the code data D to the second code addition unit 227. The second memory 225 outputs the code data D to the second code addition unit 227 at that timing.

The first code addition unit 226 calculates the first decoded data from the input code data A and C.

The second code addition unit 227 calculates the second decoded data from the input code data B and D.

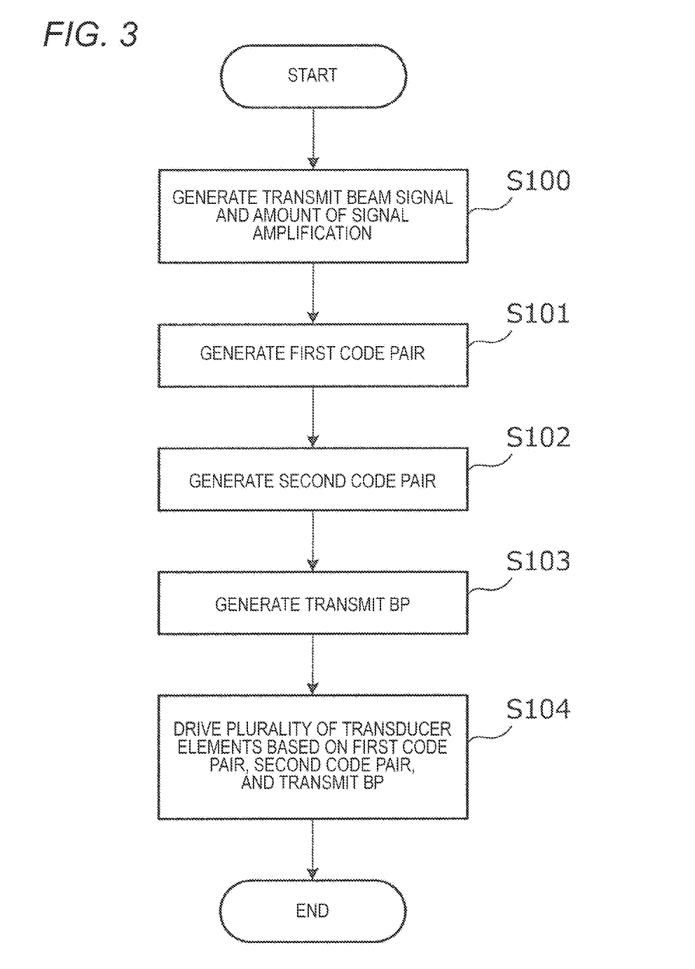

Next, the generation of a transmit ultrasonic signal for generating an ultrasonic wave in the ultrasonic signal processing apparatus 1 is described using FIG. 3.

FIG. 3 is a flowchart illustrating the process of generating a transmit ultrasonic signal in the transmission control unit.

When having accepted a control signal from the operator, the operating unit 110 generates a transmit beam signal including at least the number of transmit transducer elements and a transmit aperture position, and first and second code signals including at least the amount of signal amplification (Step S100). “Number of transmit transducer elements” here indicates the number of transducer elements 100 driven by the control signal among the plurality of transducer elements 100. Moreover, “transmit aperture position” indicates the position of the transducer element 100 driven by the control signal. Moreover, “amount of signal amplification” indicates an expected amount of amplification of an ultrasonic signal upon the decoding process.

Next, when having received the first code signal from the operating unit 110, the first code generation unit 200 determines a code length (chip) and code patterns from the amount of signal amplification included in the first code signal, and generates the first code pair being a code pair that satisfies a perfect complementary sequence relationship (Step S101). Here, the code pair satisfying the perfect complementary sequence relationship indicates a code pair that, in two sets of Golay code sequences, an aperiodic cross-correlation function of one sequence belonging to one Golay code sequence set and one sequence belonging to the other Golay code sequence set, and an aperiodic cross-correlation function of the other sequence to the one Golay code sequence set and the other sequence belonging to the other Golay code sequence set sum to zero at any shift. Let a Golay code sequence set {C1, C2} and a Golay code sequence set {C3, C4} be a perfect complementary sequence pair, which can be expressed by (Equation 3).

$$\{ \begin{matrix}C 1 = [ c {1}_{1} , c {1}_{2} , … c {1}_{L} ] , C 2 = [ c {2}_{1} , c {2}_{2} , … c {2}_{L} ] \\ C 3 = [ c {3}_{1} , c {3}_{2} , … c {3}_{L} ] , C 4 = [ c {4}_{1} , c {4}_{2} , … c {4}_{L} ]\end{matrix} \qquad [ Math . 3 ]$$

A perfect complementary code pair C is made, which satisfies the condition of (Equation 4).

$${RC}_{C 1 , C 3} ( τ ) + {RC}_{C 2 , C 4} ( τ ) = {\sum }_{n = 1}^{L - τ} ( c {1}_{n} C {4}_{L - n - 1} + c {2}_{n} c {4}_{L - n - 1} ) = 0 \qquad [ Math . 4 ]$$

Here, RC denotes a cross-correlation function. In terms of the code pattern, all patterns that satisfy the condition of (Equation 5) are assumed. The first code pair consists of a first code string G1 and a second code string G2 as indicated by (Equation 5).

G1={C1,C3} G2={C2,C4} [Math. 5]

In other words, the first code generation unit 200 generates the first code pair consisting of the first code string G1 formed by aligning the first code pattern C1 and the third code pattern C3, and the second code string G2 formed by aligning the second code pattern C2 and the fourth code pattern C4. At this point in time, as described above, the first code pattern C1 and the second code pattern C2, and the third code pattern C3 and the fourth code pattern C4 are two pairs of complementary sequences that respectively satisfy the complementary sequence relationship. Furthermore, the first code pattern C1 and the third code pattern C3, and the second code pattern C2 and the fourth code pattern C4 are two pairs of orthogonal codes that respectively satisfy an orthogonal code relationship. In short, the first code string G1 and the second code string G2 satisfy the perfect complementary sequence relationship.

Next, when having received the second code signal from the operating unit 110, the second code generation unit 201 determines a code length (chip) and code patterns from the amount of signal amplification included in the second code signal, and generates the second code pair (Step S102). Here, the second code pair consists of a third code string G3 and a fourth code string G4 as indicated by (Equation 6). Moreover, the third code string G3 and the fourth code string G4 consist of one of the perfect complementary code pair forming the first code pair, and a pause code pair, and can be expressed by (Equation 6).

G3={B,C3} G4={B,C4} [Math. 6]

Here, B denotes a pause code pattern B and can be expressed by (Equation 7).

B=[b₁, b₂, . . . b_{L}] (b_{N}=0, N=1˜L) [Math. 7]

In other words, the second code generation unit 201 generates the second code pair consisting of the third code string G3 in which one (the first code pattern C1) of the code patterns of the first code string G1 is replaced with the pause code pattern, and the fourth code string G4 in which a code pattern (the second code pattern C2) of the second code string G2, which makes a complementary sequence pair with the one (the first code pattern C1) of the code patterns, is replaced with the pause code pattern. The pause code pattern is a code indicating a state where a code is not being transmitted, and is, for example, zero as in (Equation 7).

Next, when having received the transmit beam signal from the operating unit 110, the transmit BF 111 calculates a transmit beam profile (hereinafter referred to as the “transmit BP”) from the transmit beam signal, the transmit beam profile including at least a first transducer element number TA1, a second transducer element number TA2, a first transmit aperture position 300, a second transmit aperture position 301, and a delay profile (Step S103). Here, “first transducer element number TA1” indicates the number of transducer elements that are driven based on the first code pair upon the transmission of an ultrasonic wave to the subject. “Second transducer element number TA2” indicates the number of transducer elements that are driven based on the second code pair. Moreover, the first transducer element number TA1 and the second transducer element number TA2 satisfy the condition of (Equation 8).

TA₁≧TA₂ [Math. 8]

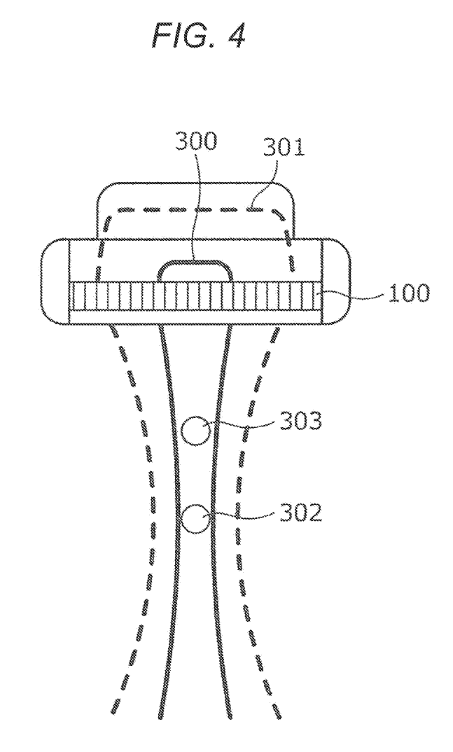

Next, FIG. 4 is a diagram for illustrating the first transmit aperture position 300 and the second transmit aperture position 301 in the transducer element array in an ultrasonic probe.

The first transmit aperture position 300 indicates a predetermined position of one or more transducer elements that are driven based on the first code pair among the plurality of transducer elements 100 of the transducer element array 2. The second transmit aperture position 301 indicates a predetermined position of a plurality of transducer elements that are driven based on the second code pair among the plurality of transducer elements 100 of the transducer element array 2. Here, the first transmit aperture position 300 is located at a position sandwiched by the second transmit aperture position 301. In other words, the first transmit aperture position 300 is surrounded by the second transmit aperture position 301, and is in the center of the plurality of transducer elements 100 forming the transducer element array 2. In contrast, the second transmit aperture position 301 surrounds the perimeter of the first transmit aperture position 300 and at ends of the plurality of transducer elements 100 forming the transducer element array 2. In addition, the second transmit aperture position 301 is separated at one or more points. The delay profile is calculated from a focus position 302 based on an area of interest desired by the operator to draw.

Steps S101 to S103 are processed in series in such a manner as that Step S102 is performed after Step S101, and Step S103 is performed after Step S102. However, Steps S101 to S103 may be processed in parallel, concurrently, after Step S100.

Next, the pulser 112 generates drive signals using the first code pair generated by the first code generation unit 200, the second code pair generated by the second code generation unit 201, and the transmit BP generated by the transmit BF 111, and drives the plurality of transducer elements 100 based on the generated drive signals (Step S104). More specifically, the pulser 112 outputs the first code string G1 of the first code pair at a first timing, and the second code string G2 at a second timing later than the first timing, to one or more first transducer elements (in other words, the transducer elements in the first transmit aperture position 300) among the plurality of transducer elements 100 of the transducer element array 2. The pulser 112 further outputs the third code string G3 at the first timing, and the fourth code string G4 at the second timing, to a plurality of second transducer elements arranged in the position sandwiching the first transducer element(s) (in other words, the transducer element(s) in the second transmit aperture position 301) among the plurality of transducer elements 100. In this manner, the pulser 112 outputs the first code string G1 and the third code string G3 at the first timing, and the second code string G2 and the fourth code string G4 at the second timing, and accordingly generates ultrasonic waves from the transducer element array 2.

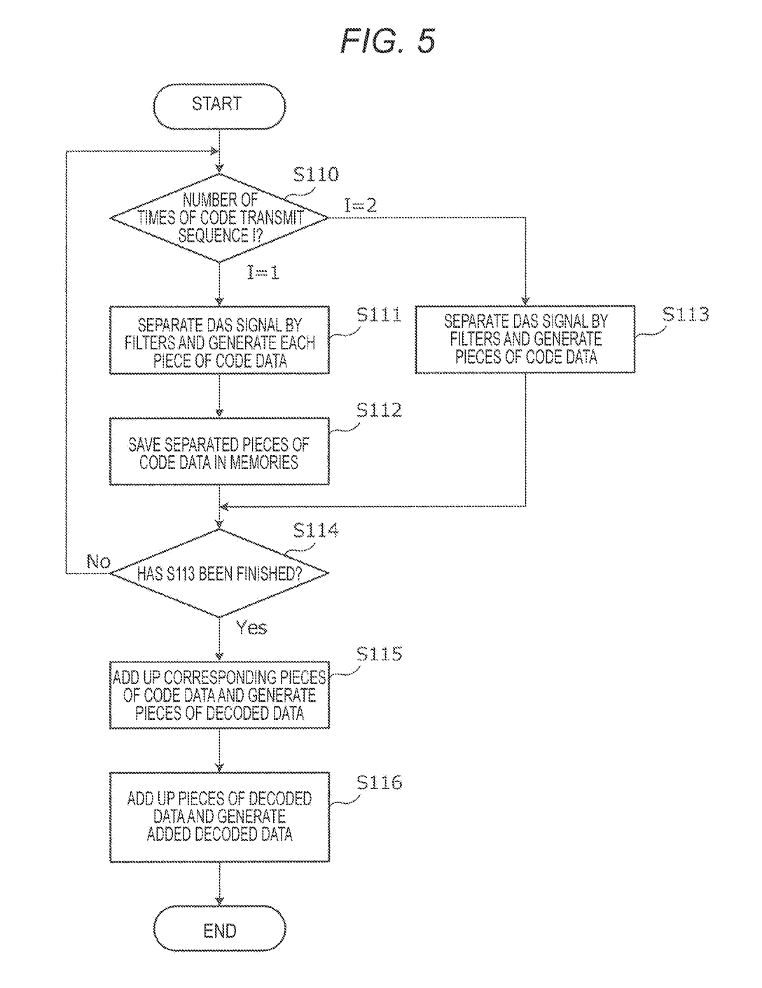

Next, a decoding process of a receive ultrasonic signal included in the received echo in the ultrasonic signal processing apparatus 1 is described using FIG. 5.

FIG. 5 is a flowchart illustrating the method for decoding the receive ultrasonic signal in the reception control unit.

When having received the DAS signal generated by the receive BF 120, the decoding processing unit 210 judges a code transmit sequence I (Step S110). The decoding processing unit 210 performs the process of Step S111 in a case of a first-time code transmit sequence I (Step S110: I=1). The decoding processing unit 210 performs the process of Step S112 in a case of a second-time code transmit sequence (Step S110: I=2). Here, “code transmit sequence” is the number of times of transmission and reception necessary for decoding, the number of times being one or more. Transmission and reception are performed continuously or at arbitrary intervals.

Next, in the case of the first-time code transmit sequence (Step S110: I=1), when the first filtering processing unit 220 and the second filtering processing unit 221 have respectively received the DAS signal from the receive BF 120, the decoding processing unit 210 performs predetermined filtering processes on the DAS signal (Step S111). Consequently, the DAS signal is separated into the code data A and the code data B. Here, let a filter A used in a first filtering process performed by the first filtering processing unit 220 be FA, and a filter B used in a second filtering process performed by the second filtering processing unit 221 be FB. FA and FB are expressed by (Equation 9).

$$\{ \begin{matrix}FA = [ c {1}_{L} , c {1}_{L - 1} , … c {1}_{1} ] \\ FB = [ c {3}_{L} , c {3}_{L - 1} , … c {3}_{1} ]\end{matrix} \qquad [ Math . 9 ]$$

Here, the filters A and B are called matched filters, and include codes having the elements, arranged in reverse order, of the Golay code sequences C1 and C3. Moreover, let the code data A be DG_{A} and let the code data B be DG_{B}. DG_{A} and DG_{B} are expressed by (Equation 10).

DG_{A}=DS*FA, DG_{B}=DS*FB [Math. 10]

Here, DS denotes DAS signal data. The symbol * denotes convolution.

Next, the first memory 224 receives the code data A from the first filtering processing unit 220. The second memory 225 receives the code data B from the second filtering processing unit 221. The first memory 224 and the second memory 225 save the data in their respective memory spaces until a predetermined timing (Step S112). Here, “predetermined timing” indicates a timing when the first memory 224 and the second memory 225 respectively pass the code data A and the code data B to the first code addition unit 226 and the second code addition unit 227, and is specifically a timing when Step S113 ends.

In other words, after Steps S112 and S113, the decoding processing unit 210 determines whether or not the third filtering processing unit 222 and the fourth filtering processing unit 223 have finished their filtering processes (Step S114). If the filtering processes have been finished (Step S114: Yes), processing proceeds to the next Step S115. If the filtering processes have not been finished (Step S114: No), the processing returns to Step S110. Consequently, Step S115 is performed only after the case where the number of times of the code transmit sequence I=2.

Next, in the case of the second-time code transmit sequence (Step S110: I=2), when the third filtering processing unit 222 and the fourth filtering processing unit 223 have respectively received the DAS signal from the receive BF 120, the decoding processing unit 210 performs the predetermined filtering processes on the DAS signal (Step S113). Consequently, the DAS signal is separated into the code data C and the code data D. Here, let a filter C used in the first filtering process performed by the third filtering processing unit 222 be FC, and a filter D used in the second filtering process performed by the fourth filtering processing unit 223 be FD. FC and FD are expressed by (Equation 11).

$$\{ \begin{matrix}FC = [ c {2}_{L} , c {2}_{L - 1} , … c {2}_{1} ] \\ FD = [ c {4}_{L} , c {4}_{L - 1} , … c {4}_{1} ]\end{matrix} \qquad [ Math . 11 ]$$

Here, the filters C and D are called matched filters, and include codes having the elements, arranged in reverse order, of the Golay code sequences C2 and C4. Moreover, let the code data C be DG_{C} and let the code data D be DG_{D}. DG_{C} and DG_{D} are expressed by (Equation 12).

DG_{C}=DS*FC, DG_{D}=DS*FD [Math. 12]

In other words, the decoding processing unit 210 performs the first filtering process for extracting one of the Golay code sequence set {C1, C2} and the Golay code sequence set {C3, C4} (here, the Golay code sequence set {C1, C2}), which are two pairs of complementary sequences, and the second filtering process for extracting the other of the Golay code sequence set {C1, C2} and the Golay code sequence set {C3, C4} (here, the Golay code sequence set {C3, C4}), on a first echo of an ultrasonic wave output at the first timing in accordance with the first code string G1 and the third code string G3 and reflected in the subject, and a second echo of an ultrasonic wave output at the second timing in accordance with the second code string G2 and the fourth code string G4 and reflected in the subject, among the echoes received by the receive BF 120. In short, the filtering processes using the filters A and C are performed as the first filtering process for extracting the Golay code sequences {C1, C2}. Moreover, as the second filtering process, the filtering processes using the filters B and D are performed as the second filtering process for extracting the Golay code sequences {C3, C4}. When the filtering process using the filter A is performed, the signal including the code pattern C1 is decoded, and the signal including the code pattern C3 is cancelled. When the filtering process using the filter B is performed, the signal including the code pattern C1 is cancelled, and the signal including the code pattern C3 is decoded. When the filtering process using the filter C is performed, the signal including the code pattern C2 is decoded, and the signal including the code pattern C4 is cancelled. When the filtering process using the filter D is performed, the signal including the code pattern C2 is cancelled, and the signal including the code pattern C4 is decoded. In other words, the first filtering process can also be said to be a process for cancelling the Golay code sequences {C3, C4}. Moreover, the second filtering process can also be said to be a process for cancelling the Golay code sequences {C1, C2}.

This is because the code patterns C1 and C3 are a pair of orthogonal codes, and the code patterns C2 and C4 are a pair of orthogonal codes. The filtering processes are performed. Accordingly, the code patterns C1 and C3 can be respectively separated from the signals including the code patterns C1 and C3. Similarly, the code patterns C2 and C4 can be respectively separated from the signals including the code patterns C2 and C4.

Next, the code addition unit 211 calculates first decoded data DG1 and second decoded data DG2 from the code data A to D (Step S115). Specifically, the first code addition unit 226 receives the code data C being the result processed by the third filtering processing unit 222, and the code data A held in the first memory 224, and calculates the first decoded data DG1 from the code data A and the code data C. Furthermore, the second code addition unit 227 receives the code data D being the result processed by the fourth filtering processing unit 223, and the code data B held in the second memory 225, and calculates the second decoded data DG2 from the code data B and the code data D. Here, the first decoded data DG1 and the second decoded data DG2 can be expressed by (Equation 13).

DG1=DG_{A}+DG_{C}, DG2=DG_{B}+DG_{D} [Math. 13]

In other words, the code addition unit 211 adds first results being the results of the first filtering process on both of the first and second echoes (in other words, the code data A and the code data C), and adds second results being the results of the second filtering process on both of the first and second echoes (in other words, the code data B and the code data D).

Next, when having received the first decoded data DG1 added in the first code addition unit 226 and the second decoded data DG2 added in the second code addition unit 227, the code addition unit 211 calculates added decoded data DGS by further adding the first decoded data DG1 and the second decoded data DG2 (Step S116). Here, the added decoded data DGS is expressed by (Equation 14).

DGS=DG1+DG2 [Math. 14]

As described above, the ultrasonic signal processing apparatus 1 can transmit both of an ultrasonic wave through a transmit aperture set to be small, and an ultrasonic wave through a transmit aperture being larger than the transmit aperture and including at least the transmit aperture, in one ultrasonic transmission using pairs in the complementary sequence relationship. In addition, the ultrasonic signal processing apparatus 1 can visualize the inside of a subject in both areas forward and backward of the focus position of the ultrasonic wave with high precision since both of the ultrasonic waves can be separated easily.

In the above description, the first code pair has been explained as (Equation 6). However, the first code pair is not limited to this. The first transmit code may be configured to have the codes in reverse order, or to nest the codes.

Moreover, the second code pair has been explained as (Equation 7). However, the second code pair is not limited to this. The second transmit code may be configured to have the codes in reverse order, or to nest the codes.

Moreover, the second transducer element number TA2 may be calculated using (Equation 15).

$${TA}_{2} = \frac{id}{F} \qquad [ Math . 15 ]$$

Here, id denotes an image quality improvement position 303 in FIG. 4. F denotes the F-number. The image quality improvement position 303 may be freely set by the operator, or may be a position specified by reading a value preset in the ultrasonic signal processing apparatus. The image quality improvement position 303 is a position desired to enhance the improved effects of the azimuth resolution, and is set forward of the focus position 302.

In other words, the transmission control unit 3 may determine not to oscillate the transducer element 100, to oscillate the transducer element 100 as the first transducer element, or to oscillate the transducer element 100 as the second transducer element, based on a predetermined F-number, for each of the plurality of transducer elements 100 forming the transducer element array 2.

Moreover, the transmission control unit 3 may determine not to oscillate the transducer element 100, to oscillate the transducer element 100 as the first transducer element, or to oscillate the transducer element 100 as the second transducer element, based on the position accepted by the operating unit 110, for each of the plurality of transducer elements 100 forming the transducer element array 2.

### Second Embodiment

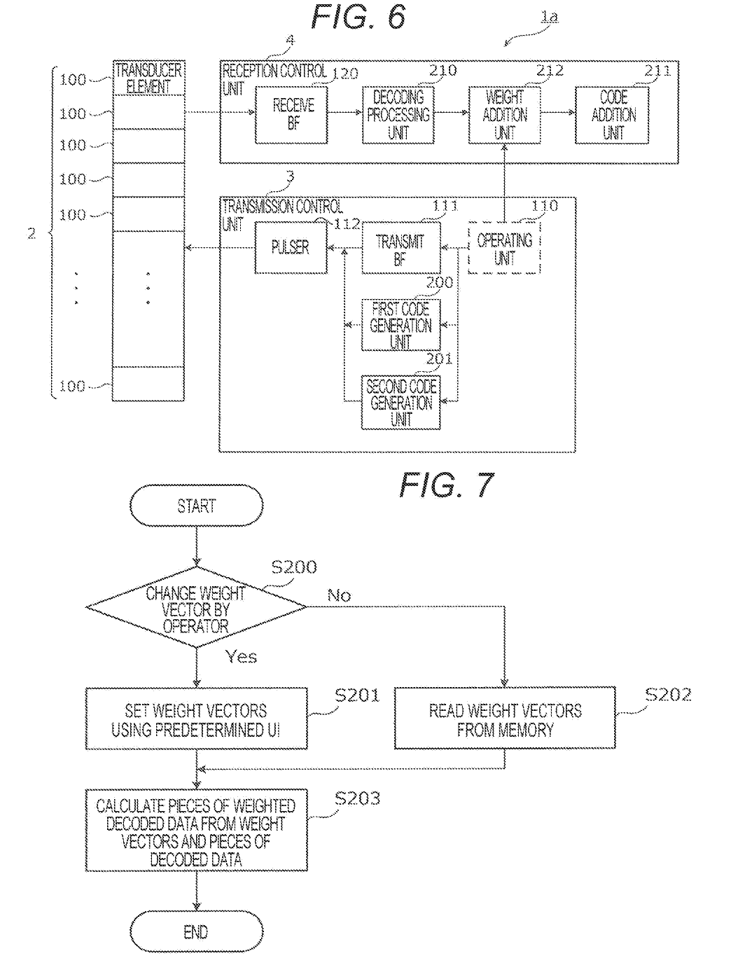

FIG. 6 is a block diagram illustrating the configuration of an ultrasonic signal processing apparatus according to a second embodiment. Hereinafter, the same reference numerals are used for similar configurations to those of the ultrasonic signal processing apparatus 1 of the first embodiment, and their descriptions are omitted. An ultrasonic signal processing apparatus la includes a weight processing unit 212 in addition to the configuration of the first embodiment.

A description is given to the inter-configuration of the block diagram of the ultrasonic signal processing apparatus 1a using FIG. 6.

The weight processing unit 212 calculates first weighted decoded data and second weighted decoded data based on the first and second decoded data calculated by the decoding processing unit 210, and a weight control signal and weight setting signal input by the operating unit 110, and outputs the first and second weighted decoded data to the code addition unit 211. In other words, the weight processing unit 212 multiplies the first result pair (in other words, the code data A and C) by its corresponding first weight and multiplies the second result pair (in other words, the code data B and D) by its corresponding second weight. “Weight control signal” is a signal indicating information for determining a first weight vector WM1 (WA1) as the first weight, and a second weight vector WM2 (WA2) as the second weight, which are described below. “Weight setting signal” is a signal indicating whether the operator has selected a weight vector control method, or a method using a weight prestored in the apparatus.

Next, the process of generating the first and second weighted decoded data in the ultrasonic signal processing apparatus 1a is described using FIG. 7.

FIG. 7 is a flowchart illustrating the process of generating the first and second weighted decoded data in the weight processing unit.

When having received the weight setting signal from the operating unit 110, the weight processing unit 212 determines the weight vector setting method. If the operator controls the weight vector (in other words, if the weight vector is changed by an input accepted by the operating unit 110), processing proceeds to the process of Step S201 and, if the value (weight) prestored in the apparatus is read and used, processing proceeds to the process of Step S202 (Step S200). Specifically, in Step S201, if the operating unit 110 accepts an input indicating that the operator changes the weight vector by inputting into the operating unit 110, processing proceeds to the process of Step S201. Moreover, in Step S201, if the operating unit 110 accepts an input indicating to read and use the weight prestored in the apparatus, processing proceeds to the process of Step S202.

Next, if the weight setting signal indicates that the method in which the operator controls the weight vector has been selected (Step S200: Yes), the weight processing unit 212 calculates the predetermined first weight vector WM1 and second weight vector WM2 from the weight control signal received from the operating unit 110 (Step S201). The first weight vector WM1 and the second weight vector WM2 are expressed by (Equation 16).

$$\{ \begin{matrix}WM 1 = [ wm {1}_{1} , wm {1}_{2} , … wm {1}_{N} ] \\ WM 2 = [ wm {2}_{1} , wm {2}_{2} , … wm {2}_{N} ]\end{matrix} \qquad [ Math . 16 ]$$

Here, N denotes the number of pieces of data in the depth direction of the first and second decoded data calculated by the decoding processing unit 210. Moreover, in terms of the predetermined first weight vector WM1 and second weight vector WM2, an arbitrary value is set for each value of or each plurality of values of the first weight vector WM1 and the second weight vector WM2 while the operator uses a dial device, slide device, button device, touch display device, or the like that is a physical user interface. Moreover, the first weight vector WM1 and the second weight vector WM2 may be set using a software graphical user interface.

Next, if the weight setting signal indicates that the method in which the value prestored in the apparatus is read and used (Step S200: No), the weight processing unit 212 determines the predetermined first weight vector WA1 and second weight vector WA2 from the weight control signal received from the operating unit 110 (Step S202). In this case, the first weight vector signal WA1 and the second weight vector signal WA2 are expressed by (Equation 17).

$$\{ \begin{matrix}WA 1 = [ wa {1}_{1} , wa {1}_{2} , … wa {1}_{N} ] \\ WA 2 = [ wa {2}_{1} , wa {2}_{2} , … wa {2}_{N} ]\end{matrix} \qquad [ Math . 17 ]$$

Here, N denotes the number of pieces of data in the depth direction of the first and second decoded data calculated by the decoding processing unit 210. Moreover, the predetermined first weight vector WA1 and the predetermined second weight vector WA2 can be designed using fd denoting the focus position 302. The first weight vector signal WA1 is expressed by (Equation 18).

$$\{ \begin{matrix}WA 1 ( d ) = {w}_{1} & ( d \leq fd ) \\ WA 1 ( d ) = {w}_{1} - {a}_{1} d & ( d \geq fd )\end{matrix} \qquad [ Math . 18 ]$$

Here, w₁ denotes a first weight amount. a₁ denotes a first weight change amount. Moreover, the second weight vector signal WA2 is expressed by (Equation 19).

$$\{ \begin{matrix}WA 2 ( d ) = {a}_{2} d & ( d \leq fd ) \\ WA 2 ( d ) = {w}_{2} & ( d \geq fd )\end{matrix} \qquad [ Math . 19 ]$$

Here, w₂ denotes a second weight amount. a₂ denotes a second weight change amount. Furthermore, the weight vector signals may be designed in such a manner as to have a constant result in the addition of the values of the first weight vector WA1 and the second weight vector WA2. In this case, the first weight amount w₁ and the second weight amount w₂, and the first weight change amount a₁ and the second weight change amount a₂ satisfy the condition of (Equation 20).

w₁=w₂, a₁=a₂ [Math. 20]

Here, if the condition of (Equation 20) is satisfied, the first weight vector WA1 and the second weight vector WA2 can be calculated from (Equation 21).

$$\{ \begin{matrix}WA 1 ( d ) = w - \frac{w}{2 fd} d \\ WA 2 ( d ) = \frac{w}{2 fd} d\end{matrix} \qquad [ Math . 21 ]$$

Here, w denotes the weight amount.

In other words, the weight processing unit 212 may determine the first and second weights in such a manner as to be equal at the preset focus position 302 based on the focus position 302. Moreover, as indicated by (Equation 18), (Equation 19), and (Equation 21), the weight processing unit 212 may determine one (here, the second weight vector WA2) of the first weight vector WA1 and the second weight vector WA2 to be multiplied by one (here, the second result DG2) of the first and second results that are results of the decoding process on echoes of ultrasonic waves with the code patterns C3 and C4 included in common in the first and second code pairs, the ultrasonic waves having been reflected in the subject, to be smaller in an area toward forward of the focus position 302, and larger in an area toward backward of the focus position 302 than the other (here, the first weight vector WA1) of the first weight vector WA1 and the second weight vector WA2 to be multiplied by the other (here, the first result DG1) of the first and second results. Moreover, as indicated in (Equation 20), the weight processing unit 212 may determine the first weight vector WA1 and the second weight vector WA2 to be a constant value when being added up, regardless of the distance from the focus position 302.

Next, when having received the first decoded data DG1 and the second decoded data DG2, which were calculated by the decoding processing unit 210, the weight processing unit 212 calculates first weighted decoded data DGW1 and second weighted decoded data DGW2 (Step S203). More specifically, the weight processing unit 212 calculates the first weighted decoded data DGW1 from the first decoded data DG1 and the first weight vector WM1 (WA1), and calculates the second weighted decoded data DGW2 from the second decoded data DG2 and the second weight vector WM1 (WA2). Here, the first weighted decoded data DGW1 and the second weighted decoded data DGW2 can be expressed by (Equation 22) or (Equation 23).

$$\begin{matrix}\{ \begin{matrix}DGW 1 = DG 1 \times WM {1}^{T} \\ DGW 2 = DG 2 \times WM {2}^{T}\end{matrix} & [ Math . 22 ] \\ \{ \begin{matrix}DGW 1 = DG 1 \times WA {1}^{T} \\ DGW 2 = DG 2 \times WA {2}^{T}\end{matrix} & [ Math . 23 ]\end{matrix}$$

As described above, the ultrasonic signal processing apparatus la can generate the first weighted decoded data DGW1 and the second weighted decoded data DGW2, which have been obtained by doing multiplications with predetermined weight vectors in the depth direction. Hence, the first decoded data DG1, which is highly precise at shallow depths, can be enhanced at shallow depths forward of the focus position 302. The second decoded data DG2, which is highly precise at deep depths, can be enhanced at deep depths backward of the focus position 302.

In the above description, the first weight vector WA1 and the second weight vector WA2 are explained as (Equation 18) and (Equation 19), but are not limited to them. The first weight vector WA1 and the second weight vector WA2 may be those expressed as linear functions that can generally be conceived by the person in the art. Moreover, the first weight vector WA1 and the second weight vector WA2 may be generated using not only linear functions but non-linear functions.

Moreover, the first weight vector WA1 and the second weight WA2 are calculated from fd denoting the focus position 302. However, id denoting the image quality improvement position 303 may be used instead of fd denoting the focus position 302.

(Modifications)

(1)

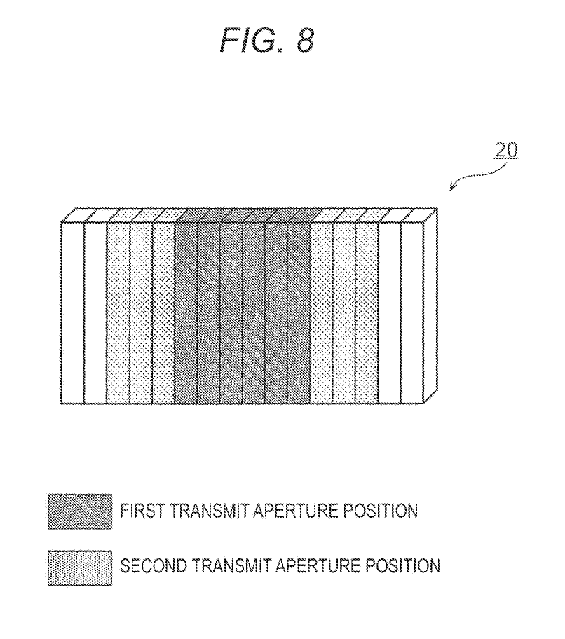

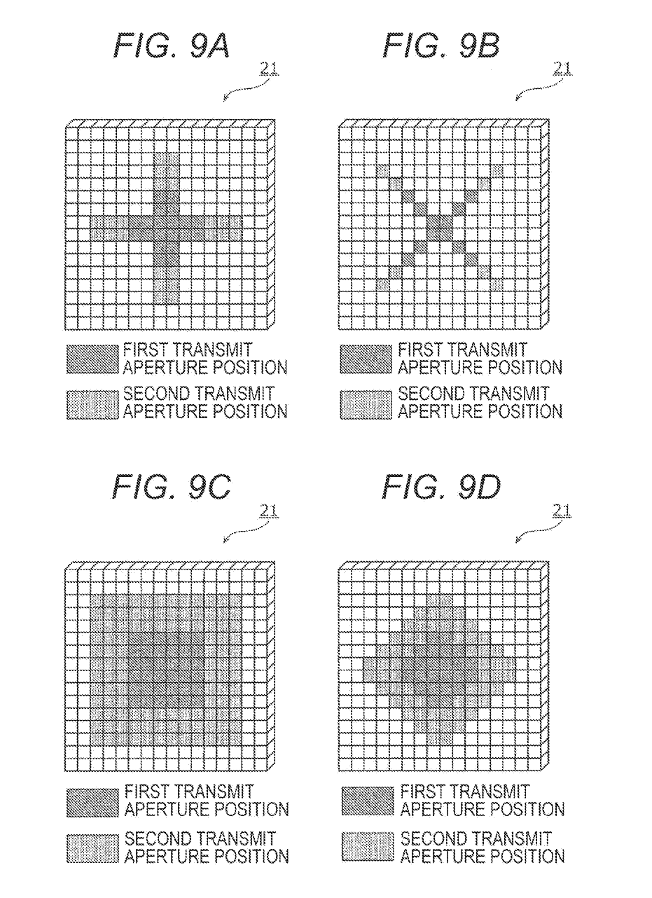

In the ultrasonic signal processing apparatuses 1 and la according to the first and second embodiments, a specific configuration of the transducer element array 2 is not mentioned. However, it may be, for example, such a transducer element array 20 as illustrated in FIG. 8, in which the plurality of transducer elements 100 is lined one-dimensionally, or such a transducer element array 21 as illustrated in FIG. 9, in which the plurality of transducer elements 100 is lined two-dimensionally.

If the plurality of transducer elements 100 is lined one-dimensionally as illustrated in FIG. 8, for example, five transducer elements 100 lined up in the center may be set as the first transducer elements lined up in the first transmit aperture position, and six transducer elements in groups of three sandwiching the first transducer elements as the center from both sides may be set as the second transducer elements lined up in the second transmit aperture position.

Moreover, if the plurality of transducer elements 100 is lined two-dimensionally as illustrated in (a) to (d) of FIG. 9, among the plurality of transducer elements 100, transducer elements 100 arranged in the center may be set as the first transducer elements lined in the first transmit aperture position, and transducer elements 100 arranged around the first transducer elements may be set as the second transducer elements lined in the second transmit aperture position, as illustrated in (a) to (d) of FIG. 9.

(2)

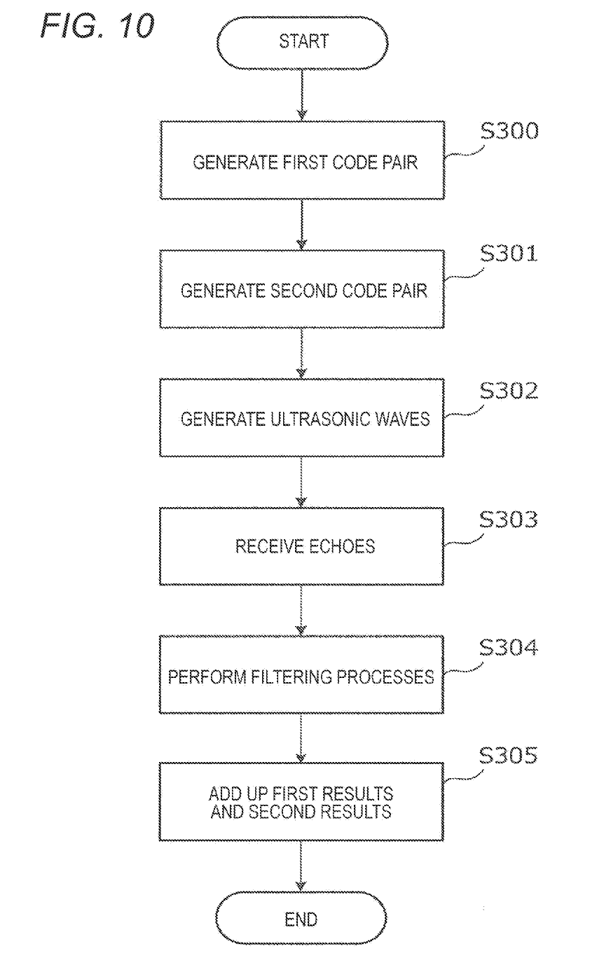

Moreover, in the ultrasonic signal processing apparatuses 1 and 1a according to the first and second embodiments, the process to be performed by the transmission control unit 3 and the process to be performed by the reception control unit 4 are separated for the sake of description, but are not limited to it. As illustrated in FIG. 10, they may be performed in one process flow. FIG. 10 is a flowchart for illustrating an ultrasonic signal processing method to be performed by the ultrasonic signal processing apparatus.

Firstly, the first code generation unit 200 generates the first code pair consisting of the first code string G1 formed by aligning the first code pattern C1 and the third code pattern C3, and the second code string G2 formed by aligning the second code pattern C2 and the fourth code pattern C4 (Step S300: a first code generation step).

Next, the second code generation unit 201 generates the second code pair consisting of the third code string G3 in which one (the first code pattern C1) of the code patterns of the first code string G1 is replaced with the pause code pattern, and the fourth code string G4 in which the code pattern (the second code pattern C2) of the second code string G2, which makes a complementary sequence pair with the one (the first code pattern C1) of the code patterns, is replaced with the pause code pattern (Step S301: a second code generation step).

Next, the pulser 112 (i) outputs the first code string G1 of the first code pair at the first timing and the second code string G2 at the second timing later than the first timing, to the one or more first transducer elements among the plurality of transducer elements 100, and (ii) outputs the third code string G3 at the first timing, and the fourth code string G4 at the second timing, to the plurality of second transducer elements arranged in the position sandwiching the one or more first transducer elements, and accordingly generates ultrasonic waves from the transducer element array 2 (Step S302: an ultrasonic wave generation step).

Next, the transducer element array 2 receives echoes of the ultrasonic waves generated by the transducer element array 2 and reflected in the subject (Step S303: a reception step).

Next, the first filtering process by the first filters (the filters A and C) for extracting the one of the two pairs of complementary sequences, and the second filtering process by the second filters for extracting the other pair of complementary sequences are performed on the first echo of the ultrasound output at the first timing in accordance with the first and third code strings and reflected in the subject, and the second echo of the ultrasonic wave output at the second timing in accordance with the second and fourth code strings and reflected in the subject, among the echoes received in Step S303 (S304: a decoding process step).

Next, the first results being the results of the first filtering process on the first and second echoes are added up, and the second results being the results of the second filtering process on the first and second echoes are added up (S305: a signal addition step).

(3)

Moreover, in the embodiments, the components may be configured by dedicated hardware, or may be realized by executing software programs suitable for the components. The components may be realized by a program execution unit such as a CPU or processor reading and executing a software program recorded in a recording medium such as a hard disk or semiconductor memory. Here, the software that realizes the ultrasonic signal processing apparatuses and the like of the embodiments is such a program as described below.

In other words, the program causes a computer to execute an ultrasonic signal processing method in an ultrasonic signal processing apparatus including a transducer element array, having a plurality of transducer elements, for emitting an ultrasonic wave to a subject and receiving an echo of the ultrasonic wave reflected in the subject, a transmission control unit for causing the transducer element array to generate an ultrasonic wave, and a reception control unit for processing the echo received by the transducer element array, the ultrasonic signal processing method comprising: in a case where (i) a first code pattern and a second code pattern, and a third code pattern and a fourth code pattern are two pairs of complementary sequences that respectively satisfy a complementary sequence relationship, and (ii) the first code pattern and the third code pattern, and the second code pattern and the fourth code pattern are two pairs of orthogonal codes that respectively satisfy an orthogonal code relationship, a first code generation step of generating a first code pair including a first code string formed by aligning the first code pattern and the third code pattern, and a second code string formed by aligning the second code pattern and the fourth code pattern; a second code generation step of generating a second code pair including a third code string in which one of the code patterns of the first code string is replaced with a pause code pattern, and a fourth code string in which a code pattern of the second code string, which makes a complementary sequence pair with the one of the code patterns, is replaced with the pause code pattern; an ultrasonic generation step of (i) outputting the first code string of the first code pair at a first timing and the second code string at a second timing later than the first timing, to one or more first transducer elements among the plurality of transducer elements, and (ii) outputting the third code string of the second code pair at the first timing and the fourth code string at the second timing, to a plurality of second transducer elements arranged in a position sandwiching the first transducer element(s), and accordingly causing the transducer element array to generate the ultrasonic waves; a reception step of receiving the echoes by the transducer element array; a decoding process step of performing a first filtering process by a first filter for extracting one of the two pairs of complementary sequences and a second filtering process by a second filter for extracting the other pair of complementary sequences, on both of a first echo of an ultrasonic wave output at the first timing in accordance with the first and third code strings and reflected in a subject, and a second echo of an ultrasonic wave output at the second timing in accordance with the second and fourth code strings and reflected in the subject, among the echoes received by the transducer element array; and a code addition step of adding first results being results of the first filtering process on both of the first and second echoes, and adding second results being results of the second filtering process on both of the first and second echoes.

(Other Modifications)

The present invention has been described based on the embodiments. However, the present invention is not limited to the embodiments, and also includes the following cases.

(1) A case where all or part of each of the apparatuses are configured of a computer system including a microprocessor, a ROM, a RAM, and a hard disk unit. A computer program that achieves operations similar to those of the apparatuses is stored in the RAM or hard disk unit. The microprocessor operates in accordance with the computer program, and accordingly the apparatuses achieve their functions.

(2) Part or all of the components forming each of the apparatuses may include one system LSI (Large Scale Integration (large scale integrated circuit)). The system LSI is a super multifunctional LSI produced by integrating a plurality of configuration units on one chip, and is specifically a computer system configured including a microprocessor, a ROM, and a RAM. A computer program that achieves operations similar to those of the apparatuses is stored in the RAM. The microprocessor operates in accordance with the computer program, and accordingly the system LSI achieves its function. Moreover, it is not limited to an LSI, but maybe realized by a dedicated circuit or a general purpose processor. An FPGA (Field Programmable Gate Array) that can be programmed after the manufacture of the LSI, or a reconfigurable processor that can reconfigure the connection and setting of a circuit cell in the LSI may be used.

(3) Part or all of the components forming each of the apparatuses may include an IC card or a discrete module that is detachable from the apparatuses. The IC card or module is a computer system including a microprocessor, a ROM, and a RAM. The IC card or module may include the above super multifunctional LSI. The microprocessor operates in accordance with a computer program and accordingly the IC card or module achieves its function. The IC card or module may have tamper resistance.

(4) The present invention may be methods to be realized by the processes of the computer illustrated above. Moreover, the present invention may be a computer program to be realized by executing these methods by a processor such as a CPU, or may be digital signals included in the computer program.

Moreover, the present invention maybe the computer program or digital signals recorded in a computer readable recording medium. Examples of the computer readable recording medium include a flexible disk, a hard disk, a CD-ROM, a MO, a DVD, a DVD-ROM, a DVD-RAM, a BD (Blu-ray (registered trademark) Disc), and a semiconductor memory. Moreover, the present invention maybe the digital signals recorded in these recording media.

Moreover, the present invention may transmit the computer program or digital signals via an electrical communication line, wireless or wired communication line, a network as represented by the Internet, data broadcasting, and the like.

Moreover, the present invention may be a computer system including a microprocessor and a memory. The computer program may be stored in the memory. The microprocessor may operate in accordance with the computer program.

Moreover, the program or digital signals may be recorded and transferred in the recording medium, or transferred via the network or the like, to be executed by another stand-alone computer system.

(5) The embodiments and modifications may be combined.

Moreover, all the numerics used in the above description are illustrated by example for specifically describing the present invention. The present invention is not limited to the illustrated numerics.

Moreover, the functional block division in the block diagrams is an example. A plurality of functional blocks may be realized as one functional block. Alternatively, one functional block may be divided into a plurality of functional blocks, or part of the functions may be moved to another functional block. Moreover, the functions of a plurality of functional blocks having similar functions maybe processed in parallel or time-division processed by single hardware or software.

Moreover, the order of execution of the above steps is illustrated by example for specifically describing the present invention. The order may be one other than the above order. Moreover, part of the steps may be executed concurrently (in parallel) with another step.

Furthermore, various modifications where changes have been made to the embodiments within a range that can be conceived by those skilled in the art are also included in the present invention unless they depart from the gist of the present invention.

### INDUSTRIAL APPLICABILITY

As described above, the present invention is useful as an ultrasonic signal processing apparatus and ultrasonic signal processing method that can improve a trade-off relationship between the resolution at shallow depths and the sensitivity at deep depths in the generation of an ultrasonic image.

### REFERENCE SIGNS LIST

1, 1a Ultrasonic signal processing apparatus
2, 20, 21 Transducer element array
3 Transmission control unit
4 Reception control unit
100 Transducer element
110 Operating unit
111 Transmit BF
112 Pulser
120 Receive BF
200 First code generation unit
201 Second code generation unit
210 Decoding processing unit
211 Code addition unit
212 Weight processing unit
220 First filtering processing unit
221 Second filtering processing unit
222 Third filtering processing unit
223 Fourth filtering processing unit
224 First memory
225 Second memory
226 First code addition unit
227 Second code addition unit
300 First transmit aperture position
301 Second transmit aperture position
302 Focus position
303 Image quality improvement position
C1 First code pattern
C2 Second code pattern
C3 Third code pattern
C4 Fourth code pattern
G1 First code string
G2 Second code string
G3 Third code string
G4 Fourth code string

1. An ultrasonic signal processing apparatus comprising:
a transducer element array, including a plurality of transducer elements, for emitting an ultrasonic wave to a subject and receiving an echo of the ultrasonic wave reflected in the subject;
a transmission control unit that causes the transducer element array to generate an ultrasonic wave in accordance with an encoded signal; and
a reception control unit that decodes a signal in accordance with the echo received by the transducer element array, wherein
in a case where (i) a first code pattern and a second code pattern, and a third code pattern and a fourth code pattern are two pairs of complementary sequences respectively satisfying a complementary sequence relationship, and (ii) the first code pattern and the third code pattern, and the second code pattern and the fourth code pattern are two pairs of orthogonal codes respectively satisfying an orthogonal code relationship,
the transmission control unit includes
a first code generation unit that generates a first code pair having a first code string formed by aligning the first code pattern and the third code pattern, and a second code string formed by aligning the second code pattern and the fourth code pattern,
a second code generation unit that generates a second code pair having a third code string in which one of the code patterns of the first code string is replaced with a pause code pattern, and a fourth code string in which a code pattern of the second code string, which makes the pair of complementary sequences with the one of the code patterns, is replaced with the pause code pattern, and
a pulser that causes the transducer element array to generate the ultrasonic waves by (i) outputting the first code string of the first code pair at a first timing, and the second code string at a second timing later than the first timing, to one or more first transducer elements among the plurality of transducer elements, and (ii) outputting the third code string of the second code pair at the first timing, and the fourth code string at the second timing, to a plurality of second transducer elements arranged in a position sandwiching the one or more first transducer elements, and
the reception control unit includes
a decoding processing unit that performs a first filtering process by a first filter for extracting one of the two pairs of complementary sequences, and a second filtering process by a second filter for extracting the other pair of complementary sequences, on both of a first echo of an ultrasonic wave output at the first timing in accordance with the first code string and the third code string and reflected in the subject, and a second echo of an ultrasonic wave output at the second timing in accordance with the second code string and the fourth code string and reflected in the subject, among the echoes received by the transducer element array, and
a code addition unit that adds first results being results of the first filtering process on both of the first and second echoes, and adding second results being results of the second filtering process on both of the first and second echoes.

2. The ultrasonic signal processing apparatus according to claim 1, wherein the transmission control unit determines not to oscillate the transducer element, to oscillate the transducer element as the first transducer element, or to oscillate the transducer element as the second transducer element, based on a predetermined F-number, for each of the plurality of transducer elements forming the transducer element array.

3. The ultrasonic signal processing apparatus according to claim 1, further comprising an operating unit that accepts an operator's input related to a focal length, wherein the transmission control unit determines not to oscillate the transducer element, to oscillate the transducer element as the first transducer element, or to oscillate the transducer element as the second transducer element, based on a position accepted by the operating unit, for each of the plurality of transducer elements forming the transducer element array.

4. The ultrasonic signal processing apparatus according to claim 1, further comprising a weight processing unit that multiplies the first result by a corresponding first weight thereof, and multiplying the second result by a corresponding second weight thereof.

5. The ultrasonic signal processing apparatus according to claim 4, wherein the weight processing unit determines the first and second weights to be equal at a preset focus position based on the focus position.

6. The ultrasonic signal processing apparatus according to claim 5, wherein the weight processing unit determines one of the first and second weights to be multiplied by one of the first and second results being results of the decoding process on echoes of ultrasonic waves with code patterns included in common in the first and second code pairs, the ultrasonic waves having been reflected in the subject, to be smaller in an are more forward of the focus position and be larger in an area toward backward of the focus position, than the other of the first and second weights to be multiplied by the other of the first and second results.

7. The ultrasonic signal processing apparatus according to claim 4, wherein the weight processing unit determines the first and second weights to be a constant value upon being added up, regardless of a distance from the focus position.

8. An ultrasonic signal processing method in an ultrasonic signal processing apparatus including
a transducer element array, having a plurality of transducer elements, for emitting an ultrasonic wave to a subject and receiving an echo of the ultrasonic wave reflected in the subject,
a transmission control unit that causes the transducer element array to generate an ultrasonic wave, and
a reception control unit that processes the echo received by the transducer element array, the ultrasonic signal processing method comprising:
in a case where (i) a first code pattern and a second code pattern, and a third code pattern and a fourth code pattern are two pairs of complementary sequences respectively satisfying a complementary sequence relationship, and (ii) the first code pattern and the third code pattern, and the second code pattern and the fourth code pattern are two pairs of orthogonal codes respectively satisfying an orthogonal code relationship,
a first code generation step of generating a first code pair including a first code string formed by aligning the first code pattern and the third code pattern, and a second code string formed by aligning the second code pattern and the fourth code pattern;
a second code generation step of generating a second code pair including a third code string in which one of the code patterns of the first code string is replaced with a pause code pattern, and a fourth code string in which a code pattern of the second code string, which makes the pair of complementary sequences with the one of the code patterns, is replaced with the pause code pattern;
an ultrasonic wave generation step of causing the transducer element array to generate the ultrasonic waves by (i) outputting the first code string of the first code pair at a first timing and the second code string at a second timing later than the first timing, to one or more first transducer elements among the plurality of transducer elements, and (ii) outputting the third code string of the second code pair at the first timing, and the fourth code string at the second timing, to a plurality of second transducer elements arranged in a position sandwiching the first transducer element(s);
a reception step of causing the transducer element array to receive the echo;
a decoding processing step of performing a first filtering process by a first filter for extracting one of the two pairs of complementary sequences, and a second filtering process by a second filter for extracting the other pair of complementary sequences, on both of a first echo of an ultrasonic wave output at the first timing in accordance with the first code string and the third code string and reflected in the subject, and a second echo of an ultrasonic wave output at the second timing in accordance with the second code string and the fourth code string and reflected in the subject, among the echoes received by the transducer element array; and
a signal addition step of adding first results being results of the first filtering process on both of the first and second echoes, and adding second results being results of the second filtering process on both of the first and second echoes.

9. A non-transitory recording medium storing a computer readable program for causing a computer to execute the ultrasonic signal processing method according to claim 8.
